(19) United States
(12) Patent Application Publication
(10) Pub. No.: US 2016/0003351 A1
(43) Pub. Date: Jan. 7, 2016

(54) TWO-SPEED TRANSMISSION FOR VEHICLE

(71) Applicant: Hyundai Motor Company, Seoul (KR)

(72) Inventor: Jong Yun PARK, Hwaseong-si (KR)

(73) Assignee: Hyundai Motor Company, Seoul (KR)

(21) Appl. No.: 14/548,538

(22) Filed: Nov. 20, 2014

(30) Foreign Application Priority Data
Jul. 4, 2014 (KR) 10-2014-0083494

(51) Int. Cl. F16H 61/02; F16H 3/54

(52) U.S. Cl. CPC F16H 61/0213; F16H 3/54; F16H 2200/0021; F16H 2200/0034; F16H 2200/2005; F16H 2200/2033; F16H 2200/2094; F16H 2061/0232

(57) ABSTRACT

A two-speed transmission for a vehicle may include an input shaft that receives power from a motor, a planetary gear unit that receives power from the input shaft and transmits it to an output shaft, and a clutch unit that is installed on the planetary gear unit and determines an element concerning variation of a rotation speed of the motor.

### CROSS-REFERENCE TO RELATED APPLICATION

The present application claims priority of Korean Patent Application Number 10-2014-0083494 filed on Jul. 4, 2014, the entire contents of which application are incorporated herein for all purposes by this reference.

### BACKGROUND OF INVENTION

1. Field of Invention

The present invention relates to a two-speed transmission for a vehicle, and more particularly, to a two-speed transmission for a vehicle which is applicable to an electric vehicle or a hybrid vehicle.

2. Description of Related Art

A two-speed transmission for an electric vehicle of a related art embodies a high speed step and a low speed step by using a clutch and an external gear. FIG. 1a and FIG. 1b are views illustrating layouts of a two-speed transmission for an electric vehicle of a related art.

As illustrated in FIG. 1a and FIG. 1b, the two-speed transmission applied to an electric vehicle of a related art includes a friction clutch, an external gear, an one-way clutch, and a locking ring, wherein the friction clutch and the one-way clutch are operated selectively to transmit power through different routes thereby to implement a low speed step and a high speed step of the two-speed transmission.

Meanwhile, FIG. 2 is a view illustrating a layout of a two-speed transmission for an electric vehicle using a hollow input shaft.

As illustrated in FIG. 2, the two-speed transmission for an electric vehicle using a hollow input shaft includes a first and second hollow input shafts, a friction clutch, an external gear, and a shift mechanism, wherein power is transmitted selectively from the first hollow input shaft and the second hollow input shaft according to an operation of the shift mechanism thereby to implement the two-speed transmission.

As described above, the two-speed transmission for an electric vehicle of a related art needs at least three external gears as well as the one-way clutch, the locking ring, the first and second hollow input shafts and the like in order to embody two shift steps. Thus, the increase in the number of components configuring the two-speed transmission for an electric vehicle of a related art leads to an increase of its manufacturing costs and of its weight accordingly.

Further, as the number of components configuring the two-speed transmission for an electric vehicle of a related art increases, the number of components that have to be controlled increases, its acceleration ability, hill-climbing ability, and maximum speed ability of a vehicle are deteriorated, and it is disadvantageous to package the components configuring the two-speed transmission for a vehicle in a predetermined space.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with a related art and/or other problems, and the present invention is not only to provide a two-speed transmission for a vehicle improving maximum speed ability, acceleration ability, and hill-climbing ability for a vehicle compared to the vehicle with a motor reducer of a related art but also to minimize the number of its components and accordingly its manufacturing costs and weight, when being applied to an electric vehicle.

In various aspects, the present invention provides a two-speed transmission for a vehicle including: an input shaft that receives power from a motor; a planetary gear unit that receives power from the input shaft and transmits it to an output shaft; and a clutch unit that is installed on the planetary gear unit and determines an element concerning variation of a rotation speed of the motor.

The planetary gear unit may reduce the rotation speed of the motor or keep it at a constant speed. The planetary gear unit may comprise a sun gear, a pinion gear, a ring gear, and a carrier, and the sun gear is connected to the input shaft and the carrier is connected to the output shaft.

The two-speed transmission may further include a housing, wherein the clutch unit may include a dog clutch that is installed on the ring gear. The clutch unit may include a friction clutch that selectively connects the sun gear and the carrier.

The two-speed transmission for a vehicle may further include a controller that receives a variation signal of the rotation speed of the motor and transmits an operational signal to the clutch unit.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated by the accompanying drawings which are given herein below by way of illustration only, and thus are not limitative of the present invention, and wherein:

FIG. 1a and FIG. 1b are views illustrating layouts of a two-speed transmission for an electric vehicle of a related art;

FIG. 2 is a view illustrating a layout of another type of the two-speed transmission for an electric vehicle of a related art;

FIG. 3 is a view illustrating a layout of an exemplary two-speed transmission for a vehicle of the present invention;

FIG. 4 is a view illustrating operating conditions of an exemplary two-speed transmission for a vehicle of the present invention;

FIG. 5a is a graph comparing maximum speed of a vehicle equipped with an exemplary two-speed transmission of the present invention to maximum speed of the vehicle equipped with a motor reducer of the related art;

FIG. 5b is a graph comparing acceleration ability of a vehicle equipped with an exemplary two-speed transmission of the present invention to acceleration ability of the vehicle equipped with a motor reducer of the related art; and

FIG. 5c is a graph comparing hill-climbing ability of a vehicle equipped with an exemplary two-speed transmission of the present invention to hill-climbing ability of the vehicle equipped with a motor reducer of the related art.

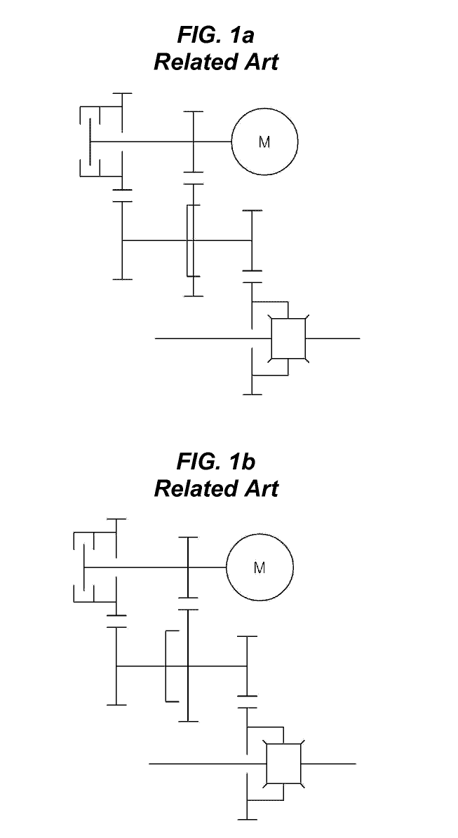

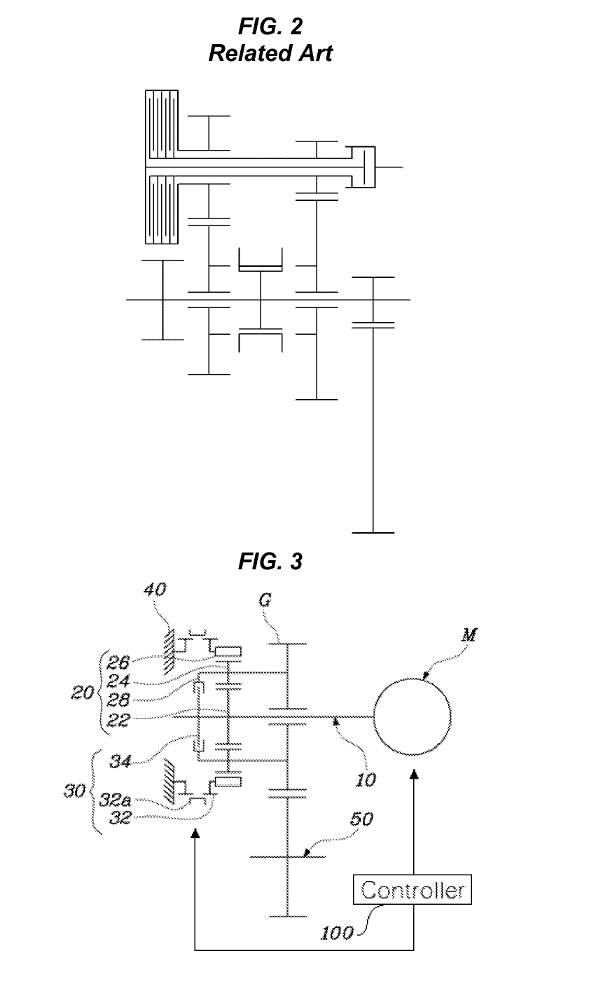

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a two-speed transmission for a vehicle according to various embodiments of the present invention is described with reference to the accompanying drawings.

As shown in FIG. 3, the present invention relates to a two-speed transmission for a vehicle by which a motor reducer of a related art in an electric vehicle or a hybrid vehicle is replaced and in which a planetary gear unit 20 and a clutch portion 30 are used to improve a motor efficiency, maximum speed ability, acceleration ability, hill-climbing ability and the like of a vehicle. According to various embodiments of the present invention, there is provided a two-speed transmission for a vehicle, including: a motor M, an input shaft 10, a planetary gear unit 20, and a clutch unit 30.

The input shaft 10 is connected to the motor M and serves to transmit rotation power of the motor M to the planetary gear unit 20 when the motor M rotates. The motor M may be normally or reversely rotatable and the input shaft 10 transmits power to the planetary gear unit 20 while it rotates normally or reversely. The planetary gear unit 20 is connected to the input shaft 10.

The planetary gear unit 20 serves to receive power of the motor M through the input shaft 10 and transmit it to an output shaft 50 wherein the rotational speed that is transmitted to the output shaft 50 is varied depending on a gear ratio between gears constituting the planetary gear unit 20.

The clutch unit 30 is installed on the planetary gear unit 20 and serves to determine the gear concerning about variation of the rotation speed of the motor M, wherein a gear ratio is controlled by connection or disconnection a plurality of gears constituting the planetary gear unit 20.

The planetary gear unit 20 includes a ring gear 26, a pinion gear 24, a sun gear 22, and a carrier 28. A center of the sun gear 22 is fixed to the input shaft 10, and is rotated in the same direction as that of the motor M.

A plurality of pinion gears 24 are installed and each of which is externally engaged with the sun gear 22, wherein each pinion gear 24 is arranged to be spaced away from each other at a constant angle to describe or form a concentric circle. An external peripheral surface of each pinion gear 24 is engaged with an inner peripheral surface of the ring gear 26 and central shafts of the pinion gears are connected to the carrier 28.

According to various embodiments of the present invention, the input shaft 10 is connected to the sun gear 22, the output shaft 50 is connected to the carrier 28, and the carrier 28 transmits power to the output shaft 50 through a driving gear G installed on the input shaft.

The clutch unit 30 serves to determine the elements concerning about the rotation speed of the motor M, as described above, wherein it connects or disconnects the sun gear 22, the pinion gear 24, the ring gear 26, and the carrier 28 constituting the planetary gear unit 20 thereby to help the rotation speed of the motor M to be varied.

The clutch unit 30 may include a friction clutch 34 and a dog clutch 32. The friction clutch 34 serves to selectively connect the sun gear 22 and the carrier 28. The dog clutch 32 is installed on the ring gear 26, wherein a sleeve 32a of the dog clutch selectively connects a housing 40 and the ring gear 26 and thereby controls the movement of the ring gear 26.

That is, when the sleeve 32a of the dog clutch 32 moves to connect the housing 40 and the ring gear 26, the ring gear 26 is fixed to the housing 40 to be restricted thereto, and when the sleeve 32a of the dog clutch 32 moves to disconnect the housing 40 and the ring gear 26, the ring gear 26 is free from the housing 40 to rotate.

In a case where the sleeve 32a of the dog clutch 32 connects the ring gear 26 and the housing 40, the ring gear 26 is kept at its fixing state, and at this time the friction clutch 34 disconnects the sun gear 22 and the carrier 28, and when the sleeve 32a of the dog clutch 32 disconnects the ring gear 26 and the housing 40, the friction clutch 34 connects the sun gear 22 and the carrier 28.

These connection and disconnection of the dog clutch 32 and the friction clutch 34 may be controlled by a controller 100 that receives a transmission signal with respect to the rotation speed of the motor M.

Referring to FIG. 3, the procedure of shifting to a first speed in the two-speed transmission for a vehicle according to various embodiments of the present invention will be described. As shown in FIG. 3, when the sleeve 32a of the dog clutch 32 connects the ring gear 26 and the housing 40, the ring gear 26 is fixed. At this time, the friction clutch 34 disconnects the sun gear 22 and the carrier 28.

The sun gear 22 transmits power of the motor M to the output shaft 50 through the carrier 28 while the ring gear 26 is fixed, wherein the sun gear 22 and the carrier 28 rotate in a same direction and at this time the rotation speed of the motor M is reduced through the carrier 28 to be transmitted to the output shaft 50. Meanwhile, when the motor M rotates reversely, a vehicle travels rearward.

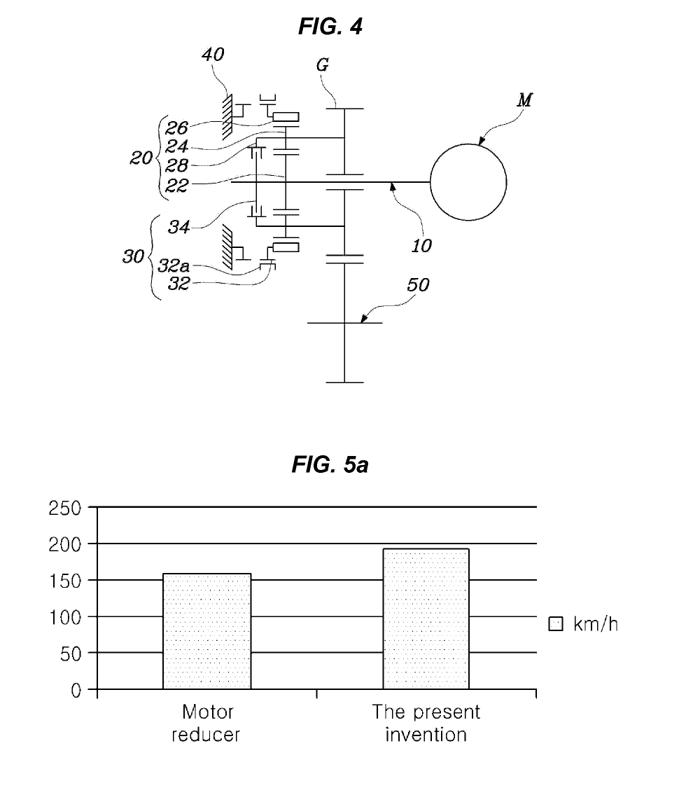

Referring to FIG. 4, a procedure of shifting to a second speed in the two-speed transmission for a vehicle according to various embodiments of the present invention will be described. As shown in FIG. 4, the sleeve 32a of the dog clutch 32 disconnects the ring gear 26 and the housing 40. At this time, the friction clutch 34 connects the sun gear 22 and the carrier 28.

The ring gear 26 is rotated in a same direction while the sun gear 22 and the carrier 28 are connected, and the sun gear 26, the carrier 28, and the ring gear 26 are rotated at the same speed. Accordingly, the rotation speed of the motor M is transmitted to the output shaft 50 at the same speed through the carrier 28.

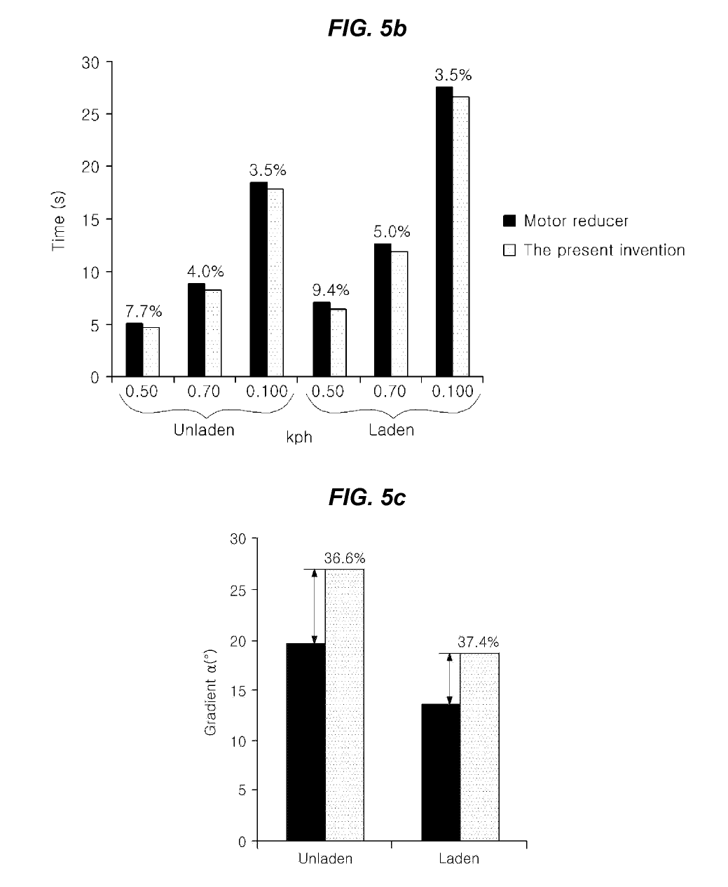

FIG. 5a is a graph comparing maximum speed of a vehicle equipped with an exemplary two-speed transmission of the present invention to maximum speed of the vehicle equipped with a motor reducer according to related art, FIG. 5b is a graph comparing acceleration ability of a vehicle equipped with an exemplary two-speed transmission of the present invention to acceleration ability of the vehicle equipped with a motor reducer according to the related art, and FIG. 5c is a graph comparing hill-climbing ability of a vehicle equipped with an exemplary two-speed transmission of the present invention to hill-climbing ability of the vehicle equipped with a motor reducer according to the related art.

As shown in the FIG. 5a, FIG. 5b, and FIG. 5c, the maximum speed of a vehicle according to various embodiments of the present invention is improved up to 193 km/h, while the maximum speed of a vehicle when used the motor reducer of a related art was about 159 km/h, and acceleration ability and hill-climbing ability of vehicle are also improved both in the laden state and in the unladen state.

The present invention has various advantageous effects including the following. First, the efficiency of the motor is improved. Second, maximum speed ability, acceleration ability, and hill-climbing ability for an electric vehicle compared to the vehicle with a motor reducer are improved. Third, the number of components of the two-speed transmission for a vehicle is minimized. Forth, the number of its controlling elements is reduced, and its control is simple. Fifth, its manufacturing costs and weight are reduced. Sixth, since a clutch is not engaged during two-speed driving, hydraulic pressure or the power of a motor is not used, improving fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A two-speed transmission for a vehicle, comprising:
an input shaft that receives power from a motor;
a planetary gear unit that receives power from the input shaft and transmits it to an output shaft; and
a clutch unit that is installed on the planetary gear unit and determines an element concerning variation of a rotation speed of the motor.

2. The two-speed transmission for a vehicle of claim 1, wherein the planetary gear unit reduces the rotation speed of the motor or keeps it at a constant speed.

3. The two-speed transmission for a vehicle of claim 2, wherein the planetary gear unit comprises a sun gear, a pinion gear, a ring gear, and a carrier, and the sun gear is connected to the input shaft and the carrier is connected to the output shaft.

4. The two-speed transmission for a vehicle of claim 3, further comprising:
a housing, wherein the clutch unit comprises a dog clutch that is installed on the ring gear.

5. The two-speed transmission for a vehicle of claim 3, wherein the clutch unit comprises a friction clutch that selectively connects the sun gear and the carrier.

6. The two-speed transmission for a vehicle of claim 4, further comprising:
a controller that receives a variation signal of the rotation speed of the motor and transmits an operational signal to the clutch unit.
